(19) United States
(12) Patent Application Publication
(10) Pub. No.: US 2025/0001397 A1
(43) Pub. Date: Jan. 2, 2025

(54) PORUS BLOCK ARTICLE

(71) Applicant: Arkema Inc., King of Prussia, PA (US)

(72) Inventors: Azaz A. VAHORA, King of Prussia, PA (US); Florence MEHLMANN, King of Prussia, PA (US)

(21) Appl. No.: 18/703,753

(22) PCT Filed: Oct. 24, 2022
(86) PCT No.: PCT/US2022/047549

§ 371 Date: Apr. 23, 2024

Related U.S. Application Data
(60) Provisional application No. 63/271,306, filed on Oct. 25, 2021.

(51) Int. Cl. B01J 20/28; B01D 15/08; B01D 39/20; B01D 53/02; B01J 20/18; B01J 20/20; C02F 1/00; C02F 1/28

(52) U.S. Cl. CPC B01J 20/28026; B01D 15/08; B01D 39/2062; B01D 39/2079; B01D 53/02; B01J 20/18; B01J 20/20; B01J 20/28004; B01J 20/28016; B01J 20/28059; C02F 1/001; C02F 1/288; B01D 2239/1241; B01D 2239/1258; B01D 2239/1291

(57) ABSTRACT

The invention relates to a composite block article having a polyamide binder interconnecting one or more types of interactive particles or fibers. The block article is useful in the separation of materials dissolved or suspended in fluids.

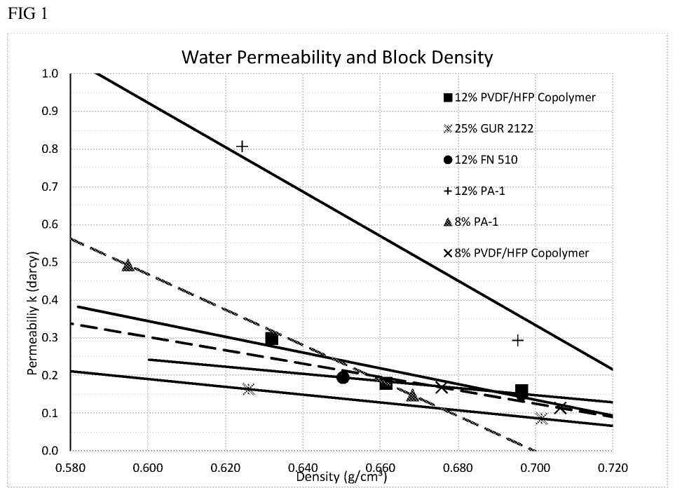

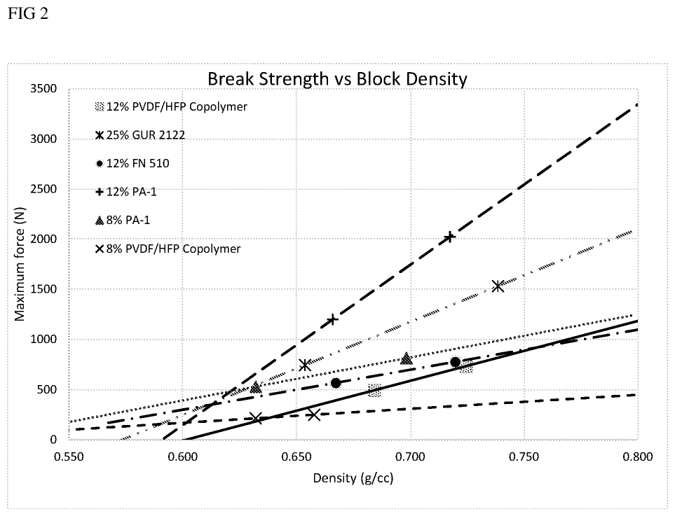

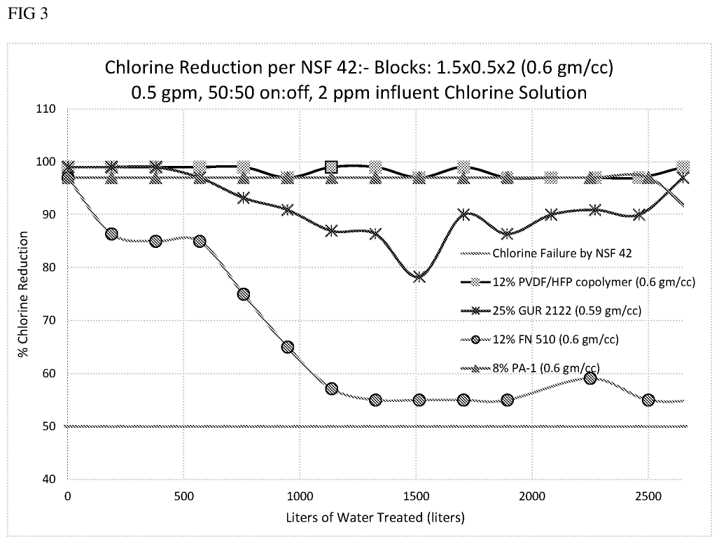

### FIELD OF THE INVENTION

The invention relates to a porous block article having a polyamide binder interconnecting one or more types of interactive powdery materials or fibers. Porous Block article with improved flow rate and strength having a small particle size, narrow particle size distribution, and porous polyamide binder.

### BACKGROUND OF THE INVENTION

The performance criteria for carbon block filters are mechanical strength, flow rate of fluid through the filter (permeability), carbon fine retention, and chemical/contaminant removal. Current binders available for carbon block filters, such as ultrahigh molecular weight polyethylene (UHMWPE), have to be added in larger amount to get adequate mechanical strength but still struggles with fine retention. Other used binders, such as low density polyethylene (LDPE) cause lower contaminant removal from the water. Kyblock binders made of polyvinylidene fluoride (PVDF) have best in class performance in chemical/contaminant removal but the mechanical strength tend to be lower. There is an unmet need for binders that can combine all performance criteria in one system.

U.S. Pat. Nos. 5,019,311, 5,147,722 and 5,331,037 describe an extrusion process to produce a porous structure containing interactive particles bound together by a polymer binder. The porous structure is described as a “continuous web matrix”, or “forced point bonds”. The composite article is useful as a high performance water filter, such as in a carbon block filter.

WO2014055473 teaches the use of PVDF and polyamide binders for use in block products. There is no teaching related to the particle size or particle size distribution of the polyamide used. There is no data to show the properties of the polyamide block.

It has now surprisingly been found that a class of polyamide binders having a small particle size, a narrow particle size distribution, and a high porosity can be used to bind interactive particles and/or fibers together in such a manner as to create interconnectivity of the particles and/or fibers. The bound particles or fibers can be formed into articles for the separation of materials dissolved or suspended in fluids. The block produced with the described polyamides have high fine retention, high permeability, high mechanical strength, and high chemical/contaminant removal.

It is generally thought that a low viscosity binder results in generally poor performance for removing chemicals/contaminants. (Viscosity measured by parallel plate rheology at 200C using 0.1 Hz frequency). Low viscosity means viscosity below 5.1E+06 Cpoise (mPa·s) at a temperature of 200C and a frequency of 0.1 Hz.

TABLE 1

| Material | Viscosity (centipoise) at 200 C. (0.1 Hz) |
|---|---|
| LDPE | 1.51E+06 |
| HDPE | 527 |
| UHMWPE | 7.42E+08 |
| PolyamidePA-1 | 1.23E+05 |
| PolyamidePA-2 | <5E+6 |
| PolyamidePA-3 | <5E+6 |
| PVDF/HFP copolymer | 7.73E+07 |

The invention relates to a porous block article having a polyamide binder interconnecting one or more types of interactive materials or fibers, preferably comprising activated carbon as an interactive material. The interconnectivity is such that the binder connects the interactive materials or fibers in discrete spots rather than as a complete coating, allowing the materials or fibers to be in direct contact with, and interact with a fluid. The resulting article is a formed multicomponent, interconnected web, with porosity. The block article is useful in water purification, as well as in the separation of dissolved or suspended materials in both aqueous and non-aqueous systems in industrial uses, and for gas storage. The block article can function at ambient temperature, as well as at elevated temperatures.

We have discovered that a class of Polyamide powder characterized in particle size, particle size distribution, and porosity surprisingly gave a carbon block with a unique combination of flow rate (permeability), mechanical strength, fine retention, and chemical/contaminant removal. This binder has potential to provide better overall performance for key aspects of the carbon block filters, unlike commercial binders.

### SUMMARY OF THE INVENTION

The invention teaches a specific class of Polyamide powder grades that have small (50 microns or less) particle size along with very narrow particle size distribution (80% of the particles have a size between 0.5 times the average particle size and 2 (two) times the average particle size)), and have high porosity (0.5 to 100 m2/g BET Specific Surface Area) for use as binder in carbon block filters. This set of binder's characteristics results in carbon block filters with high mechanical strength, high water flow rate thought the filter, high fine retention, and high chemicals/contaminants removal for potable water filtration. Additionally, when the viscosity of this type of polyamide binder is low, it still results in high chemical/contaminant removal capacity (chlorine) from drinking water, which is very different from the behavior of polyolefin binders where low viscosity results in low chemical/contaminant removal.

The invention relates to a composite block article composition comprising:
i) 1 to 15 wt % based on total block of a polyamide binder, and
ii) 99 to 85 wt % of interactive particles having an average particle size of from 0.1 to 3,000 microns, wherein said polyamide binder is characterized as having an average particle size in the range of from 1 to 50 microns, preferably 1 to 25 microns wherein the particle size distribution is such that 80% of the particles have a size between 0.5 times the average particle size and 2 (two) times the average particle size, having a BET specific surface area (in m2/g) greater than 0.5 and preferably greater than 1.4 and most preferably greater than 3 m2/g. The polyamide binder particles have high porosity as indicated by the high BET specific surface area.

### Aspects of the Invention

Aspect 1 provides A composite block article comprising:
a) 1 to 15 weight percent of a polyamide binder, and
b) 85 to 99 weight percent of interactive particles having an average particle diameter of from 0.1 to 3,000 microns, the weight percent based on the total of polyamide and interactive particles,
   wherein said polyamide has an average particle size of between 1 and 50 microns, wherein the particle size distribution is such that 80% of the particles have a size between 0.5 times the average particle size and 2 (two) times the average particle size and wherein said polyamide is porous as measured by having a specific surface area of greater than 0.5 m2/g.

Aspect 2. The composite block article of aspect 1, wherein said polyamide is selected from the group consisting of PA 6, PA 11, PA 12, PA6.12, PA6.6, or any combination thereof.

Aspect 3. The composite block article of aspect 1, wherein said polyamide comprises polyamide 6 or polyamide 12.

Aspect 4. The composite block article of any one of aspects 1 to 3, wherein the average particle size of the polyamide binder is 1 to 22 microns.

Aspect 5. The composite block article of any one of aspects 1 to 4, wherein the polyamide binder has a melt viscosity of 10000 centipoise or greater.

Aspect 6. The composite block article of any one of aspects 1 to 5, wherein the polyamide binder comprises at least 2.5 wt %, preferably at least 3 weight percent of the total weight of the composite block article.

Aspect 7. The composite block article of any one of aspects 1 to 5, wherein the polyamide binder comprises at least 5 wt %, preferably at least 6 weight percent of the total weight of the composite block article.

Aspect 8. The composite block article of any one of aspects 1 to 7, wherein the interactive particles comprise activated carbon.

Aspect 9. The composite block article of any one of aspects 1 to 8, wherein the composite block article further comprises additional polymeric binders selected from polyolefins, polyesters, PVDF, polyamide, PTFE (polytetrafluorethylene), and ethylene vinyl acetate.

Aspect 10. The composite block article of any one of aspects 1 to 9, wherein the interactive particles comprise at least one of metallic particles of 410, 304, and 316 stainless steel, copper, aluminum and nickel powders, ferromagnetic materials, activated alumina, activated carbon, carbon black, graphite, carbon nanotubes, silica gel, acrylic powders and fibers, cellulose fibers, glass beads, various abrasives, common minerals such as silica, wood chips, ion-exchange resins, ceramics, zeolites, diatomaceous earth, polyester particles and fibers, and particles of engineering resins such as polycarbonate.

Aspect 11. The composite block article of any one of aspects 1 to 10, wherein the interactive particles comprise zeolites.

Aspect 12. The composite block article of any one of aspects 1 to 11, wherein said block has a fine retention as measured by transmittance of the first liter of filtered water of greater than 75% transmittance.

Aspect 13. The composite block article of any one of aspects 1 to 12, wherein the average particle size of the polyamide binder is from 1 to 12 microns, wherein said polyamide is porous as measured by having a specific surface area of greater than 1.4 m2/g, or greater than 3 m2/g.

Aspect 14. The composite block article of any one of aspects 1 to 13, wherein said article is a part of a carbon block system for water filtration, or industrial filtration of fluids.

Aspect 15. The composite block article of any one of aspects 1 to 14, wherein said article is a hybrid article further comprising a secondary filtration system.

Aspect 16. The composite block article of any one of aspects 1 to 15, wherein said article composite block article has a permeability (Darcy value) of at least 0.310, preferably at least 0.32 or greater.

Aspect 17. The composite block article of any one of aspects 1 to 16, wherein said article has a density of between 0.58 to 0.74 g/cm3.

Aspect 18. A process for separating compounds from a fluid, comprising passing a fluid through the composite block article of any one of aspects 1 to 17.

Aspect 19. The process of aspect 18, wherein said fluid comprises dissolved, or suspended materials capable of being separated.

Aspect 20. The process of aspect 19, wherein dissolved, or suspended materials capable of being separated is selected from the group consisting of particulates; biological and pharmaceutical active ingredients; organic compounds; acids, bases, hydrofluoric acid; cations of hydrogen, aluminum, calcium, lithium, sodium, and potassium; anions of nitrate, cyanide, chloramines and chlorine; metals, chromium, zinc, lead, mercury, arsenic, copper, silver, gold, platinum, iron a; salts, sodium chloride, potassium chloride, sodium sulfate.

Aspect 21. The process of any one of aspects 18 to 20, wherein said fluid comprises a gas.

Aspect 22. The process of any one of aspects 18 to 20, wherein said fluid comprises an aqueous or non-aqueous liquid.

Aspect 23. The process of any one of aspects 18 to 20, wherein said fluid is selected from the group consisting of aqueous liquid, organic solvents, pharmaceutical or biological preparations, hydrocarbon base fluids, or blends thereof.

Aspect 24. Use of the composite block article of any one of aspects 1 to 17 as a separation/filtration device to separate a component from a fluid stream.

### DETAILED DESCRIPTION OF THE INVENTION

As used herein copolymer refers to any polymer having two or more different monomer units, and would include terpolymers and those having more than three different monomer units.

The references cited in this application are incorporated herein by reference.

“Interconnectivity”, as used herein means that the interactive particles or fibers are permanently bonded together by the polyamide binder without completely coating the interactive particles or fibers. The binder adheres the interactive particles together at specific discrete points to produce an organized, porous structure. The porous structure allows a fluid to pass through the interconnected particles or fibers, and the fluid composition is exposed directly to the surface(s) of the interactive particles or fibers, favoring the interaction of the particles with components of the fluid composition, resulting in separation of the components. Since the polymer binder adheres to the interactive particles in only discrete points, less binder is used for full connectivity than in a coating.

Percentages, as used herein are weight percentages, unless noted otherwise, and molecular weights are weight average molecular weights, unless otherwise stated.

By narrow particle size distribution we mean 80% of the particles have a size between 0.5 times the average particle size and 2 (two) times the average particle size. For example if the average particle size is 10 microns then 80% of the particles are between 5 and 20 microns, if the average particle size is 5 microns then 80% of the particles are between 2.5 and 10 microns.

Particle size analysis: The particle size distribution of the powders in the present description, is measured using a particle sizer of Coulter LS230 brand and according to Standard ISO 13319. It makes it possible to obtain the particle size distribution of the powders, from which it is possible to determine the mean diameter and the width of the distribution or the standard deviation of the distribution. The particle size distribution of the powders according to the invention is determined according to the usual techniques using a Coulter LS230 particle sizer from Beckman-Coulter. It is possible, from the particle size distribution, to determine the mean size (diameter) by volume with the logarithmic calculation method, version 2.11a of the software, and the standard deviation, which measures the narrowing in the distribution or the width of the distribution around the mean diameter.

Porosity and BET Specific surface area: The expression “porous particles” is intended to denote particles comprising pores. The porosity is characterized quantitatively by the specific surface area (also known as SSA). The porous particles of the invention exhibit a specific surface area (SSA), measured according to the BET method, of greater than or equal to 0.5 m²/g. The BET (Brunauer—Emmett—Teller) method is a method well-known to a person skilled in the art. It is described in particular in “The Journal of the American Chemical Society”, vol. 60, page 309, February 1938 and corresponds to the international standard IS09277. The specific surface area measured according to the BET method corresponds to the total specific surface area, that is to say that it includes the surface area formed by the pores.

A good filter has capability to retain particles within the block and therefore to not contaminate the filtered fluid with carbon, with any other adsorbent, or with the binder itself. By high fine retention we mean a transmittance of greater than 75% for first liter of water flushed thought the carbon block filter. The first few liters of water filtered through the carbon block is collected in jars for transmission testing. The filtered water samples were collected for the first liter and submitted to visual and transmittance tests. The lower transmission means the filtered fluid is contaminated with particles of carbon, or other adsorbents, or with the binder itself. Additionally, because finer carbon particles are known to have higher kinetic for contaminant removal, their release from the block into the filtered water means the block will have a lower performance for chemical/contaminant removal.

Permeability and Flow rate: Permeability (k) is measured using Darcy's law. A filter was placed into a housing and city water was run through. The pressure was measured on each side of the filter, and the flow rate was determined using a flow meter. Theoretically, the inlet water pressure was around 60 psi, which is a standard pressure for city water. This ability of the filter to allow the water though its pores can be quantified by the permeability k, which can be calculated using the equation derived from Darcy's Law.

$$k = \frac{Q}{Δ P} \cdot \frac{μ ( {D}_{O} - {D}_{I} )}{2 π \cdot {D}_{O} \cdot H}$$

Where k is the permeability in m2 (1 m2=1.01325E+12 darcy), Q is the flow rate in m3i·sec, ΔP is the pressure drop due to the filter (independent from the pressure drop due to the housing) in Pa (to determine the delta P for the filter, water is run though the housing with and without a filter; the difference is the pressure drop of the filter), μ is the dynamic viscosity of the fluid in Pa·s, Dₒ is the outside diameter of the filter in m, D₁ is the inside diameter of the filter in m, and H is the height of the filter in m and H is the height of the filter in m

Break strength: Mechanical strength is measured by lateral compression using a flat load moving at a speed of 1.27 mm-min-1. 2-inch tall blocks were subjected to this compression test. The maximum force applied before the block broke was reported.

Contaminant/chemical removal test: Chlorine was used as a representative contaminant/chemical to evaluate the removal capability of the carbon block filter. The chlorine reduction test was performed using NSF 42 standard protocol. The percent chlorine reduction was reported as a function of the volume of water filtered through the carbon block. Below are the condition of testing:
a. Filter: 1.5×0.5×2 inches
b. Contaminant: Chlorine
c. Flow rate: 0.5 GPM (1.89 Lit/min)
d. Input water Pressure: 60±3 PSI
e. Running cycle: 20 min ON/20 min OFF

### Polyamides

The term polyamide generally refers to the condensation products of one or more amino acids, such as aminocaproic, 7-aminoheptanoic, 11-aminoundecanoic and 12-aminododecanoic acid, or of one or more lactams such as caprolactam, oenantholactam and lauryllactam; and of one or more salts or mixtures of diamines such as hexamethylenediamine, dodecamethylenediamine, meta-xylylenediamine, bis(p-aminocyclohexyl)methane and trimethylhexamethylenediamine with diacids such as isophthalic, terephthalic, adipic, azelaic, suberic, sebacic and dodecanedicarboxylic acid.

The PA 12 can also be obtained by anionic polymerization as described in U.S. Ser. No. 12/521,082.

Examples of polyamides that may be mentioned include PA 6, PA11 and PA 12 and PA6/12.

It is also possible to make advantageous use of copolyamides. Mention may be made of the copolyamides resulting from the condensation of at least two alpha, omega-amino carboxylic acids or of two lactams or of one lactam and one alpha, omega-amino carboxylic acid. Mention may also be made of the copolyamides resulting from the condensation of at least one alpha, omega-amino carboxylic acid (or one lactam), at least one diamine and at least one dicarboxylic acid.

Examples of lactams which may be mentioned include those having 3 to 12 carbon atoms on the main ring, which lactams may be substituted. Mention may be made, for example, of β,β-dimethylpropiolactam, α,α-dimethylpropiolactam, amylolactam, caprolactam, capryllactam and lauryllactam.

Examples of alpha, omega-amino carboxylic acids that may be mentioned include aminoundecanoic acid and aminododecanoic acid. Examples of dicarboxylic acids that may be mentioned include adipic acid, sebacic acid, isophthalic acid, butanedioic acid, 1,4-cyclohexanedicarboxylic acid, terephthalic acid, the sodium or lithium salt of sulphoisophthalic acid, dimerized fatty acids (these dimerized fatty acids having a dimer content of at least 98% and preferably being hydrogenated) and dodecanedioic acid, HOOC—(CH₂)₁₀—COOH.

The diamine can be an aliphatic diamine having 6 to 12 carbon atoms; it may be of aryl and/or saturated cyclic type. Examples that may be mentioned include hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM) and bis(3-methyl-4-aminocyclohexyl)methane (BMACM).

Examples of copolyamides that may be mentioned include copolymers of caprolactam and lauryllactam (PA 6/12), copolymers of caprolactam, adipic acid and hexamethylenediamine (PA 6/6-6), copolymers of caprolactam, lauryllactam, adipic acid and hexamethylenediamine (PA 6/12/6-6), copolymers of caprolactam, lauryllactam, 11-aminoundecanoic acid, azelaic acid and hexamethylenediamine (PA 6/6-9/11/12), copolymers of caprolactam, lauryllactam, 11-aminoundecanoic acid, adipic acid and hexamethylenediamine (PA 6/6-6/11/12), and copolymers of lauryllactam, azelaic acid and hexamethylenediamine (PA 6-9/12).

Polyamide 6 and polyamide 12 and PA6/12 are especially preferred.

The polyamide binder used for the present invention is characterized by having an average particle size in the range of from 1 to 50 microns, preferably 1 to 25, more preferably 1 to 22, and even more preferably 1 to 15 microns, wherein the particle size distribution is such that 80% of the particles have a size between 0.5 times the average particle size and 2 (two) times the average particle size. The polyamide binder is porous as indicated by the high BET specific surface area.

The characteristics of the polyamide binder powders used in the invention are:
a. the small average particle size (volume mean diameter) of the particles, from 1 m to 50 μm, more advantageously still from 1 to 25 m, per Standard ISO 13319
b. the narrow particle size distribution. The particle size distribution of the powders is determined according to the usual techniques, for example using a Coulter Multisizer II particle sizer, according to Standard ISO 13319. It is possible, from the particle size distribution, to determine the mean diameter and the particle size dispersion (standard deviation), which measures the narrowing of the distribution.
c. The polyamide powder particles have a spheroidal shape; that is to say the particles are in the form of a spheroid, which means: approximately spherical solid.
d. the porosity, characterized by the specific surface area (SSA) of the powders, from 0.5 to 150 m2/g, more preferably still from 0.5 to 100 m2/g, advantageously from 0.5 to 50 m2/g, more advantageously still from 0.5 to 40 m2/g, more preferably 0.5 to 20 m2/g, and more preferably 1 to 15 m2/g, measured by nitrogen absorption according to the BET method. The SSA can be equal to or greater than 1.4 m2/g or greater than or equal to 3 m2/g. The specific surface area SSA is determined according to the BET (Brunauer-Emmet-Teller) method described in International Standard ISO 9277. The BET specific surface area corresponds to the total specific surface area (thus including micropores) of the powder.

### Interactive Particles or Fibers

One or more types of interactive particles or fibers are combined with the polyamide binder. The interactive particles or fibers of the invention are those which have a physical, electrical, or chemical interaction when they come into proximity or contact with dissolved or suspended materials in a fluid (liquid or gas) composition. Depending on the type of activity of the interactive particles, the particles may separate the dissolved or suspended materials by chemical reaction, physical entrapment, physical attachment, electrical (charge or ionic) attraction, or similar means. Examples of interactions anticipated by the invention include, but are not limited to: physical entrapment of compounds from the fluid, such as in activated carbon, catalysts; electromagnetic particles; acid or basic particles for neutralization; etc.

Examples of interactive particles or fibers include, but are not limited to: activated carbon, carbon nanotubes, silica gel, acrylic powders and fibers, wood chips. Activated carbon is particularly preferred.

Additional functional additives that may be added to the block include polymeric ion-exchange resins, ceramic ion-exchange resins, zeolites (or aluminosilicates), metal oxides (such as titanium oxide, zinc oxide, aluminum oxide, iron oxide), metals (such as silver, zinc, iron, titanium, copper, and alloys of silver, zinc, iron, titanium, and copper); phosphate minerals (such astriphylite, monazite, hinsdalite, pyromorphite, vanadinite, erythrite, amblygonite, lazulite, turquoise, autunite, phosphophyllite, struvite, xenotime); magnesium minerals (such as periclase), hydroxide minerals (such as goethitebrucite, manganite), clay mineral, mica, quartz, metal organic frame (MOF), polymeric materials (such as chitosan, lignin, polypyrrole, cellulose and cellulosics). Ion-exchange resins, zeolites and metal oxides are preferred functional additives. Zeolites are particularly preferred.

The interactive particles of the invention are in the size range of 0.1 to 3,000 micrometers in diameter and fibers of 0.1 to 250 micrometers in diameter of essentially unlimited length to width ratio. Fibers are preferably chopped to no more than 5 mm in length. Fibers or powders should have sufficient thermal conductivity to allow heating of the powder mixtures. In addition, in an extrusion process, the particles and fibers must have melting points sufficiently above the melting point of the polyamide binder to prevent both substances from melting and producing a continuous melted phase rather than the usually desired multi-phase system.

The ratio of polyamide binder to interactive particles or fibers is from 1 to 20 weight percent of polyamide to 80 to 99 weight percent interactive particles or fibers, preferably from 1-15 weight percent of polyamide to 85 to 99 weight percent interactive particles or fibers, more preferably from 1-10 weight percent of polyamide to 90 to 99 weight percent interactive particles or fibers. If less polyamide is used, complete interconnectivity may not be achieved, and if more polyamide is used, there is a reduction in contact between the interactive particles and the fluid passing through the block article.

The composite block article has a permeability (Darcy value) of at least 0.310, preferably at least 0.32 or greater.

Preferably, the composite block article used for separation will have a density of between 0.58 to 0.74 g/cm3.

The block articles of the invention differ from membranes. A membrane works by rejection filtration—having a specified pore size, and preventing the passage of particles larger than the pore size through the membrane. The block articles of the invention instead rely on adsorption or absorption by interactive particles to remove materials from a fluid passing through the block article.

The block articles of the invention, having interconnectivity of interactive particles, can be formed by means known in the art for forming articles. Useful processes for forming the block articles of the invention include, but are not limited to: an extrusion process, as taught in U.S. Pat. No. 5,019,311, compression molding, a co-spray dried powder, and an (aqueous) dispersion binding process. These process are known the art for example from WO2014055473, herein incorporated by reference.

The polyamide serves as a binder with polymer particles binding together the interactive particles or fibers only at specific discrete points to produce interconnectivity.

In one embodiment of the invention, a block article may be a hybrid filtration article comprising a secondary filter to remove large particles prior to the fluid passing through the polyamide block article. This secondary filtration component could be a larger-mesh filter, spun fibers, loose fiber fill, screens, or other known secondary filtration means. The secondary filtration could be any material, though polyamide materials could be especially useful due to their chemical and biological inertness, and high mechanical and thermo mechanical properties

### Uses

Due to the advantageous properties of polyamide materials, including mechanical, and thermo mechanical properties, compared to other binder materials such as the typically used polyethylene, the block articles of the invention can be used in a variety of different and demanding environments. The block articles can be used to purify and remove unwanted materials from the fluid passing through the block article, resulting in a more pure fluid to be used in various commercial or consumer applications. The porous block articles are especially useful for the removal of chemicals/contaminants from potable water; the separation of chemicals/contaminants from liquid or gaseous industrial streams; the capture and recovery of small molecules from fluid streams, such as gas storage, biological and pharmaceutically active moieties, and precious metals, and the performance of specific chemical reactions, such as through catalysis. Depending on the type of activity of the interactive particles, the particles may separate the dissolved or suspended materials by chemical reaction, physical entrapment (adsorption), electrical (charge or ionic) attraction, or similar means.

The block article can also be used to capture and concentrate materials from a fluid stream (“separation device”), these captured materials then removed from the block article for further use.

The separation devices can be used, for example for potable water purification (hot and cold water), and also for industrial uses. By industrial uses is meant uses at high temperatures (greater than 50° C., greater than 75° C., greater than 100° C. greater than 125° C. and even greater than 150° C., and in some applications greater than 220C, up to the softening point of the polymer binder); uses with organic solvents; uses in pharmaceutical and biological applications; uses for the removal of organic compounds from aqueous solutions and suspensions; and uses in hydrocarbon fluid cleaning or filtering.

The block can be used to remove chlorine from water. Chorine is used as a proxy for many other organic contaminants. If the block article works for chlorine it is expected that it will also work for other contaminants listed in NSF 42, such as chloroamine, foaming agent, hydrogen sulfide, chloroform etc.

Based on the list of exemplary uses, and the descriptions in this description, one of ordinary skill in the art can imagine a large variety of other uses for the composite article of the invention.

### EXAMPLES

Example 1: Filtration blocks were prepared via compression molding with an outside diameter of 1.5 inches, an inside diameter of 0.5 inches, and an approximate length of 2±0.1 inches. Blocks were processed in pre heated molds at process temperature (listed in table below) in an oven for 25-30 minutes. The blocks were prepared with between 8 to 25 wt % (weight percent) binders listed below, 8 wt % zeolite, and the balance was Jacobi Aquasorb CX Activated Carbon 80×325 mesh.

TABLE 2

| Binder | Process T (° C./F) |
|---|---|
| PVDF/HFP copolymer | 182/360 |
| UHMWPE | 171/340 |
| LLDPE | 171/340 |
| PA1 | 204/400 |
| PA2 | 204/400 |
| PA3 | 216/420 |

The retention of small particles (fine retention) was measured by filtering deionized water through the block (water flowing from the outside to the inside of the block through the whole length of the block) with a tap pressure of about 4 bar. Water was collected, 1 liter at a time, for the first 6 liters of filtration. The filtered water was collected and the transmission through a 0.5 liter glass jar was measured. The transmission value of a jar containing deionized water was 86%. Block strength (break strength) was measured on an Instron 4201 universal test frame using a compression test discuss above using a crosshead speed of 0.05 inches per minute. The flow rate through the filter was measured using flow meter and pressure was monitored before and after to calculate the permeability per Darcy's law which was also discuss above. As shown in Table below, the carbon filter with PA−1 and PA−2 binder shows better break strength, permeability, and fine retention. However, the PA−3 binder with larger size and broad particle size distribution has poor fine retention and lower flow rate compared to PA−1 and PA−2.

PA−1=polyamide with particle size of 5 microns, particle size distribution (PSD) of 2.5 to 10 microns, a BET specific surface area (SSA) of 9 m2/g surface area, and a viscosity of 123000 cpoise.
PA−2=polyamide with particle size of 10 microns, PSD of 5 to 20 microns, a BET SSA of 20 m2/gm
PA−3=grounded polyamide powder with average particle size of 25 microns, PSD of 2 to 30 micron (broad PSD), a BET SSA of less than 1 m2/gm
GUR®2122 is UHMWPE from Celanese
FN 510 is LLDPE from LyondellBasell

TABLE 3
Block Strength, Permeability and Light transmission data

| | | Binder | | | Break | Light | Light |
|---|---|---|---|---|---|---|---|
| | | amount | Density | Permeability | Strength | Transmission | Transmission |
| Sample | Binder | (wt %) | (gm/cc) | (darcy) | (N) | (%) 1 Liter | (%) 2 Liters |
| 1 | PVDF/HFP | 12 | 0.62 | 0.304 | 100 | 81.3 | 84.2 |
| | copolymer | | | | | | |
| 2 | GUR 2122 | 25 | 0.62 | 0.172 | 400 | — | — |
| 3 | FN 510 (PE) | 12 | 0.62 | 0.223 | 375 | — | — |
| 4 | PA-1 | 12 | 0.62 | 0.806 | 475 | 79.4 | 84.4 |
| 5 | PA-2 | 12 | 0.62 | 0.559 | 1100 | 77.5 | 86.2 |
| 6 | PA-3 | 12 | 0.62 | 0.495 | 1000 | 56.4 | 83.5 |
| 7 | PVDF/HFP | 12 | 0.7 | 0.137 | 600 | 81.9 | 85.1 |
| | copolymer | | | | | | |
| 8 | GUR 2122 | 25 | 0.7 | 0.086 | 1175 | 68.4 | 84.3 |
| 9 | FN 510 | 12 | 0.7 | 0.147 | 700 | 77.3 | 82.2 |
| 10 | PA-1 | 12 | 0.7 | 0.324 | 1725 | 81.3 | 85.2 |
| 11 | PA-2 | 12 | 0.7 | 0.145 | 1675 | 84.7 | 86.2 |
| 12 | PA-3 | 12 | 0.7 | 0.125 | 2000 | 74.1 | 84.8 |
| 13 | PVDF/HFP | 8 | 0.60 | 0.304 | 150 | — | — |
| | copolymer | | | | | | |
| 14 | PA-1 | 8 | 0.60 | 0.466 | 400 | 81.8 | 86.2 |
| 15 | PA-2 | 8 | 0.60 | 0.420 | 510 | 82.5 | 85.5 |
| 16 | PA-3 | 8 | 0.60 | 0.239 | 200 | 72 | 85.6 |
| 17 | PVDF/HFP | 8 | 0.65 | 0.213 | 200 | 81.0 | 85.6 |
| | copolymer | | | | | | |
| 18 | PA-1 | 8 | 0.65 | 0.233 | 800 | 83.8 | 85.6 |
| 19 | PA-2 | 8 | 0.65 | 0.209 | 625 | 85.2 | 86.4 |
| 20 | PA-3 | 8 | 0.65 | 0.170 | 650 | 75.6 | 84 |

For each block density at equivalent loading level the PA−1 and PA−2 performed better than the other binders. For a given density and loading, both the break and the permeability of the polyamide (PA−1 and PA−2) block is measurably higher than the comparative blocks.

Amongst the polyamide binders, the block with a binder with smaller size and narrow particle size distribution that is PA−1 and PA−2 measures higher flow rate and improved fine retention.

The fine retention property is better with a smaller particle binder, but it is also influenced by how the powder particles are formed. Grounded powder performs poorly at an equivalent particle size (less than 50 microns).

Example 2: Filtration blocks were prepared via compression molding with an outside diameter of 1.5 inches, an inside diameter of 0.5 inches, and an approximate length of 2±0.1 inches. Blocks were processed in pre heated molds at process temperature (listed in table in example 1) in an oven for 25-30 minutes. The Blocks were prepared using between 8, 12, or 25 wt % binders (as indicated above) and the balance was Jacobi Aquasorb CX Activated Carbon 80×325 mesh. The blocks were tested for chlorine removal from water per NSF 42 protocol using 0.5 gpm flow rate and 50:50 on:off cycle with 2 ppm chlorine in the influent water.

1. A composite block article comprising:
a) 1 to 15 weight percent of a polyamide binder, and
b) 85 to 99 weight percent of interactive particles having an average particle diameter of from 0.1 to 3,000 microns, the weight percent based on the total of polyamide and interactive particles,
wherein said polyamide has an average particle size of between 1 and 50 microns, wherein the particle size distribution is such that 80% of the particles have a size between 0.5 times the average particle size and 2 (two) times the average particle size and wherein said polyamide is porous as measured by having a specific surface area of greater than 0.5 m2/g.

2. The composite block article of claim 1, wherein said polyamide is selected from the group consisting of PA 6, PA 11, PA 12, PA6.12, PA6.6, or any combination thereof.

3. The composite block article of claim 1, wherein said polyamide comprises polyamide 6 or polyamide 12.

4. The composite block article of claim 1, wherein the average particle size of the polyamide binder is 1 to 22 microns.

5. The composite block article of claim 1, wherein the polyamide binder has a melt viscosity of 10000 centipoise or greater.

6. The composite block article of claim 1, wherein the polyamide binder comprises at least 2.5 wt % of the total weight of the composite block article.

7. The composite block article of claim 1, wherein the polyamide binder comprises at least 5 wt % of the total weight of the composite block article.

8. The composite block article of claim 1, wherein the interactive particles comprise activated carbon.

9. The composite block article of claim 1, wherein the composite block article further comprises additional polymeric binders selected from polyolefins, polyesters, PVDF, and ethylene vinyl acetate.

10. The composite block article of claim 1, wherein the interactive particles comprise at least one of metallic particles of 410, 304, and 316 stainless steel, copper, aluminum and nickel powders, ferromagnetic materials, activated alumina, activated carbon, carbon nanotubes, silica gel, acrylic powders and fibers, cellulose fibers, glass beads, various abrasives, common minerals such as silica, wood chips, ion-exchange resins, ceramics, zeolites, diatomaceous earth, polyester particles and fibers, and particles of engineering resins.

11. The composite block article of claim 1, wherein the interactive particles comprise zeolites.

12. The composite block article of claim 1, wherein said block has a fine retention as measured by transmittance of the first liter of filtered water of greater than 75% transmittance.

13. The composite block article of claim 1, wherein the average particle size of the polyamide binder is from 1 to 12 microns, wherein said polyamide is porous as measured by having a specific surface area of greater than 1.4 m2/g.

14. The composite block article of claim 1, wherein said article is a part of a carbon block system for water filtration, or industrial filtration of fluids.

15. The composite block article of claim 1, wherein said article is a hybrid article further comprising a secondary filtration system.

16. A process for separating compounds from a fluid, comprising passing a fluid through the composite block article of claim 1.

17. The process of claim 16, wherein said fluid comprises dissolved, or suspended materials capable of being separated.

18. The process of claim 17, wherein dissolved, or suspended materials capable of being separated is selected from the group consisting of particulates; biological and pharmaceutical active ingredients; organic compounds; acids, bases, hydrofluoric acid; cations of hydrogen, aluminum, calcium, lithium, sodium, and potassium; anions of nitrate, cyanide and chlorine; metals, chromium, zinc, lead, mercury, arsenic, copper, silver, gold, platinum, iron a; salts, sodium chloride, potassium chloride, sodium sulfate.

19. The process of claim 16, wherein said fluid comprises a gas.

20. The process of claim 16, wherein said fluid comprises an aqueous or non-aqueous liquid.

21. The process of claim 21, wherein said fluid is selected from the group consisting of aqueous liquid, organic solvents, pharmaceutical or biological preparations, hydrocarbon base fluids, or blends thereof.

22. (canceled)
